(19) United States
(12) Patent Application Publication
(10) Pub. No.: US 2014/0104185 A1
(43) Pub. Date: Apr. 17, 2014

(54) TOUCH DISPLAY DEVICE AND HANDHELD ELECTRONIC DEVICE

(71) Applicant: HTC CORPORATION, (US)

(72) Inventors: Chih-Jen Hu, Taoyuan County (TW); Ming-Tien Lin, Taoyuan County (TW); Chih-Shan Yeh, Taoyuan County (TW)

(73) Assignee: HTC CORPORATION, Taoyuan County (TW)

(21) Appl. No.: 13/651,467

(22) Filed: Oct. 15, 2012

(51) Int. Cl. G06F 3/041

(52) U.S. Cl. CPC G06F 3/041
USPC 345/173

(57) ABSTRACT

A touch display device includes a display panel and a touch panel. The touch panel includes a first flexible substrate and a sensing circuit. The first flexible substrate includes a body disposed on the display panel and an extension portion located outside the display panel, in which the extension portion is connected to the body and adapted to bend relatively to the body. The sensing circuit includes a plurality of first connection lines disposed on the first flexible substrate. In addition, the disclosure also discloses a handheld electronic device with the above-mentioned touch display device.

### BACKGROUND

1. Field of the Disclosure

The disclosure generally relates to a display device and an electronic device with the display device, and more particularly, to a touch display device and a handheld electronic device with the touch display device.

2. Description of Related Art

In recent years, the input devices of various electronic devices have been changed to the touch panels as the input devices from the traditional keyboards or mouses. Therefore, the user only needs its finger to touch the screen of the electronic device for reading data or inputting data.

In general, in accordance with the sensing methods the touch panels can be roughly divided into resistive touch panels, capacitive touch panels, optical touch panels, acoustic wave touch panels and electromagnetic touch panels, in which the resistive and capacitive touch panels are the mainstream on the market. In terms as the capacitive touch panel, where a plurality of transparent conductive sensing pads are bonded onto the substrate to form a touch sensing array. Accordingly, users just slightly touch the surface to get induction to be able operating the touch panel with advantages of fast response time, good reliability and high durability.

FIG. 1 is a schematic cross-sectional view of a conventional electronic apparatus. Refer to FIG. 1, an electronic device 100 includes a body 110, and a display module 120, a touch panel 130 and a transparent upper cover 140 all assembled in the body 110. The touch panel 130 has a plurality of sensing electrodes (not shown) disposed thereon and is connected to the corresponding control components via a plurality of connection lines 132, so that the electronic device 100 has touch function. In addition, the peripheral of the transparent upper cover 140 has a shielding portion 142 for shielding the connecting lines 132 or other opaque member at the edge of the touch panel 130, so as to avoid the above-mentioned lines and members from being exposed.

However, due to the screen appearance design is developed towards the lightweight and large-size display, the display module 120 needs to meet the requirements of the slim border design and the displaying area of the screen needs to be increased, which are accomplished usually by reducing the non-display area located at the screen peripheral such as the above-mentioned shielding portion 142.

### SUMMARY OF THE DISCLOSURE

Accordingly, the disclosure is directed to a touch display device capable of reducing the non-displaying area surrounding the screen, advance the design flexibility of the space inside the device and conform with the design requirement of slim boarder for getting a bigger displaying area.

The disclosure is further directed to a handheld electronic device using the above-mentioned touch display device.

The disclosure provides a touch display device, which includes a display panel and a touch panel. The touch panel includes a first flexible substrate and a sensing circuit. The first flexible substrate includes a body disposed on the display panel and an extension portion located outside the display panel, in which the extension portion is connected to the body and adapted to bend relatively to the body. The sensing circuit includes a plurality of first connection lines disposed on the first flexible substrate.

The disclosure further provides a handheld electronic device, which includes a casing and an above-mentioned touch display device. The casing has an accommodation opening and the touch display device is disposed in the accommodation opening.

Based on the description above, in the touch display device provided by the disclosure, during assembling the touch panel, the extension portion of the first flexible substrate is bent along the folding line so that a part of the first connection lines on the extension portion is located at the side edge of the display panel and there is no need to use a shielding portion to shield the part of the first connection lines. In other words, the design of the disclosure can reduce the non-displaying area of the touch display device to meet the design requirement of slim boarder. In addition, since the line-width of the first portion of each the first connection line passing through the folding line is greater than the line-width of the second portion, it can enhance the strength of the first connection lines at the bending place, avoid the fracture of the first connection lines caused by the bending of the first flexible substrate along the folding line and help to advance the reliability of the product.

In order to make the features and advantages of the present disclosure more comprehensible, the present disclosure is further described in detail in the following with reference to the embodiments and the accompanying drawings.

### BRIEF DESCRIPTION OF THE DRAWINGS

FIG. 1 is a cross-sectional view of a conventional electronic apparatus.

FIG. 2 is a cross-sectional view of a handheld electronic device according to an embodiment of the disclosure.

FIG. 3 is a cross-sectional view of the touch panel of FIG. 2 when it is outspread.

FIGS. 4 and 5 are bottom views of the touch panel of FIG. 3.

FIG. 6 is a cross-sectional view of a handheld electronic device according to another embodiment of the disclosure.

FIG. 7 is a cross-sectional view of a handheld electronic device according to yet another embodiment of the disclosure.

FIG. 8 is a cross-sectional view of the touch panel of FIG. 7 when it is outspread.

FIG. 9 is a partial enlarged view of the folding line of FIG. 4 at an area A1.

FIG. 10 is a partial enlarged view of the folding line of FIG. 4 at the area A1 according to another embodiment of the disclosure.

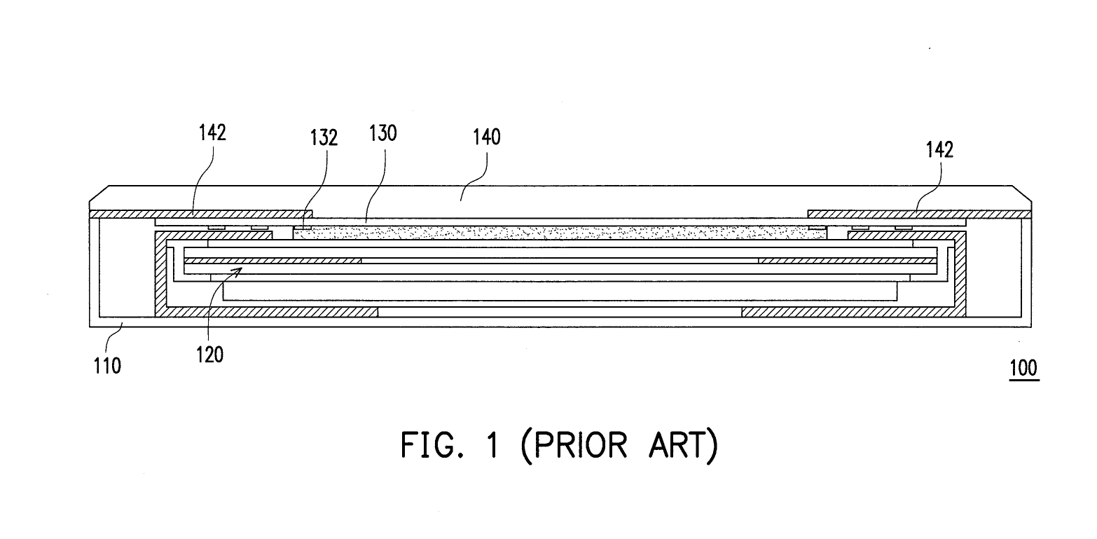

### DESCRIPTION OF THE EMBODIMENTS

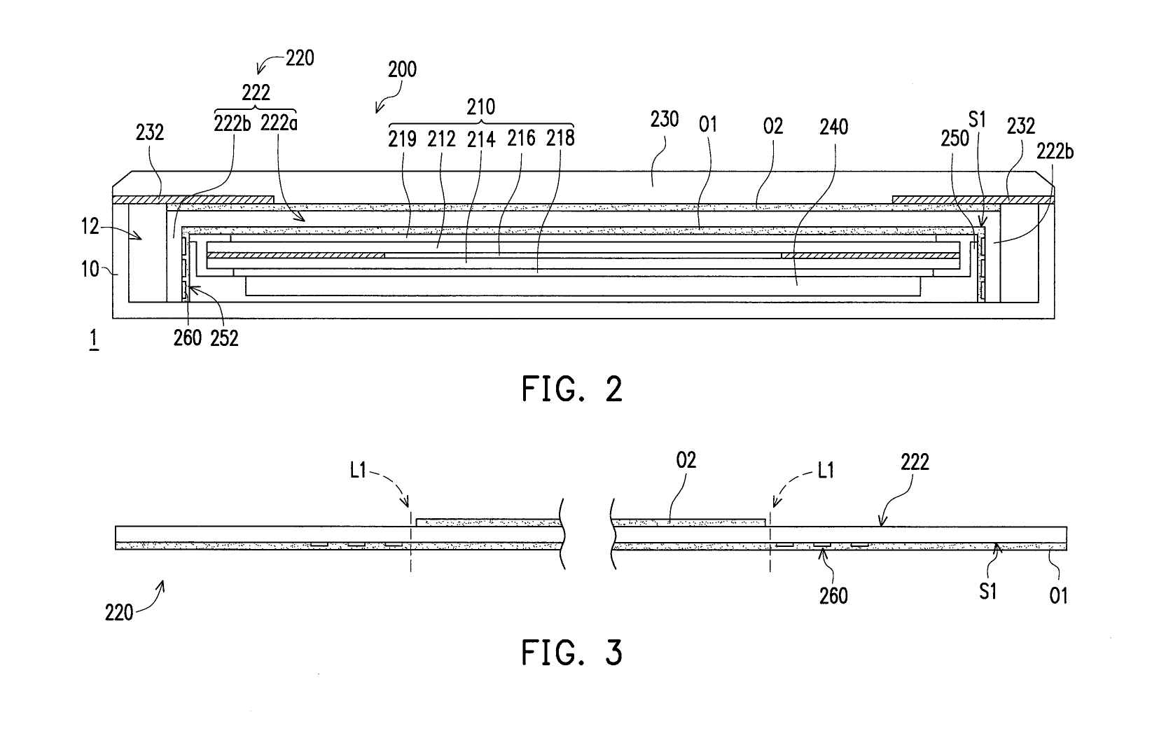

FIG. 2 is a cross-sectional view of a handheld electronic device according to an embodiment of the disclosure and FIG. 3 is a cross-sectional view of the touch panel of FIG. 2 when it is outspread. Referring to FIGS. 2 and 3, in the embodiment, a handheld electronic device 1 includes a casing 10 and a touch display device 200. The casing 10 has an accommodation opening 12 and the touch display device 200 is disposed in the accommodation opening 12. The touch display device 200 includes a display panel 210 and a touch panel 220. The handheld electronic device 1 of the embodiment is, for example, a mobile phone, a tablet computer or an eBook. The disposed touch panel 220 enable the handheld electronic device 1 having touch function. It should be noted that for better understanding the views, the ratio of the touch panel 220 in FIG. 3 is adjusted already.

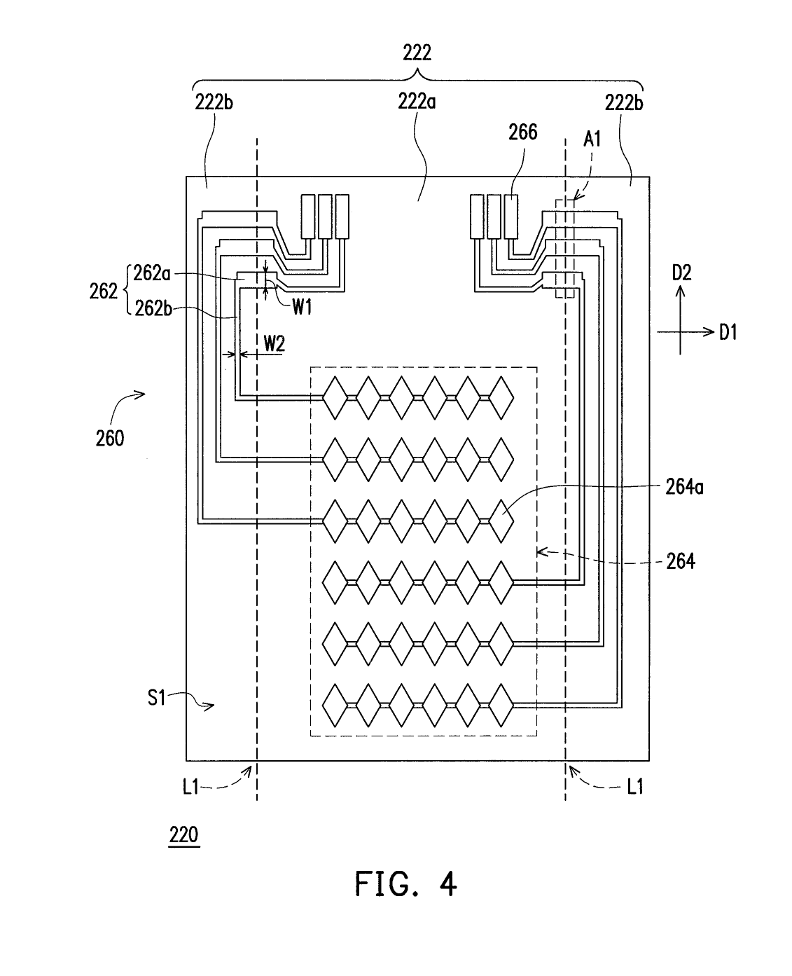

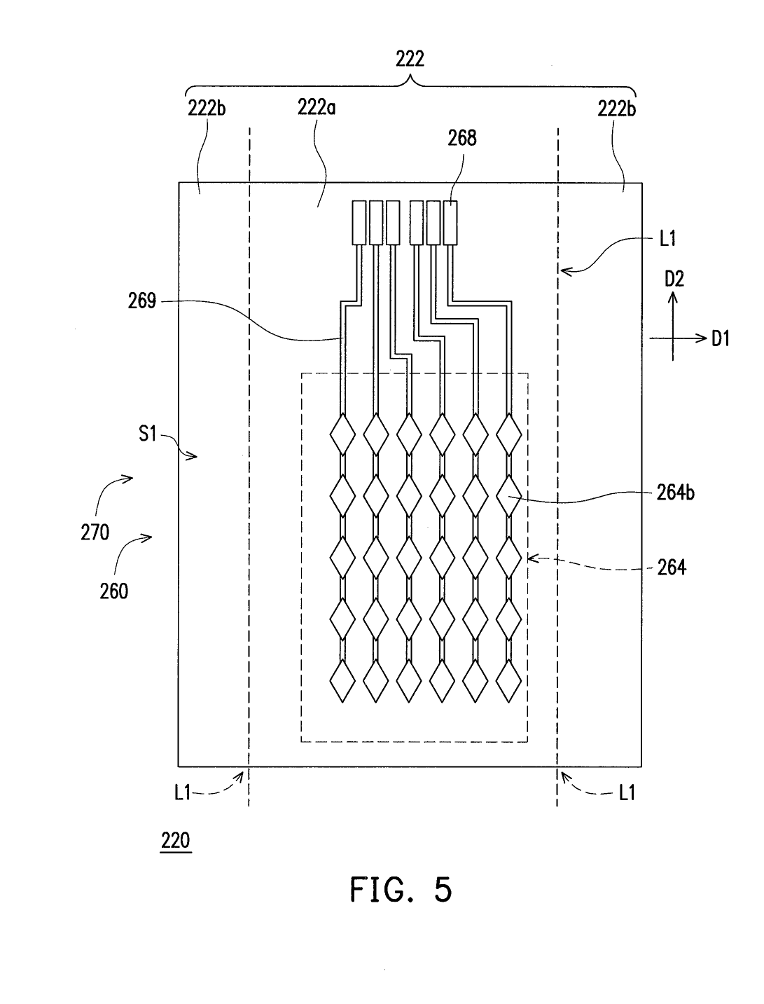

FIGS. 4 and 5 respectively show sensing circuit layouts with two directions on the touch panel 220 of FIG. 3, where the sensing circuits may be fabricated on different substrates or integrally fabricated on a same substrate.

Referring to FIGS. 4, 2 and 3, the touch panel 220 includes a first flexible substrate 222 and a first sensing circuit 260. The first flexible substrate 222 includes a body 222a disposed on the display panel 210 and an extension portion 222b located outside the display panel 210, in which the material of the first flexible substrate 222 is, for example, polyethylene terephthalate (PET) or other similar materials. The extension portion 222b is connected to the body 222a and adapted to bending along a folding line L1 relatively to the body 222a. The first sensing circuit 260 is located on a first surface S1 of the first flexible substrate 222 and includes a plurality of first connection lines 262 disposed on the first surface Si of the first flexible substrate 222. Each of the first connection lines 262 has a first portion 262a passing through the folding line L1 and a second portion 262b located outside the first portion 262a. After the extension portion 222b is bent along the folding line L1, the first connection lines 262 located at the edge of the first flexible substrate 222 turns to the side edge of the display panel 210, so that partial first connection lines 262 can be hidden. In this way, the light-shielding area at the display device can be reduced.

In addition, since the line-width W1 of the first portion 262a of each of the first connection lines 262 is greater than the line-width W2 of the second portion 262b, when the extension portion 222b bends along the folding line L1 relatively to the body 222a, the first portion 262a of each first connection line 262 after bending can maintain a certain strength due to the above-mentioned reason, i.e., the line-width W1 of the first portion 262a passing through the folding line L1 is greater than the line-width W2 of the second portion 262b (located outside the first portion 262a), which can avoid the first connection lines 262 from fracture to fail transmitting the signals.

In more details, the line-width W1 of the first portion 262a of each of the first connection lines 262 is, for example, between 0.1 μm and 10 μm; or the line-width W1 of the first portion 262a of each of the first connection lines 262 is, for example, between 3 μm and 5 μm. In, addition, the material of each first connection line 262 can be metal so that the first connection lines 262 at bending have better ductility. For example, the material of each first connection line 262 can be copper or gold. In addition, the folding line L1 in the embodiment can be formed by using different processes, as description in following.

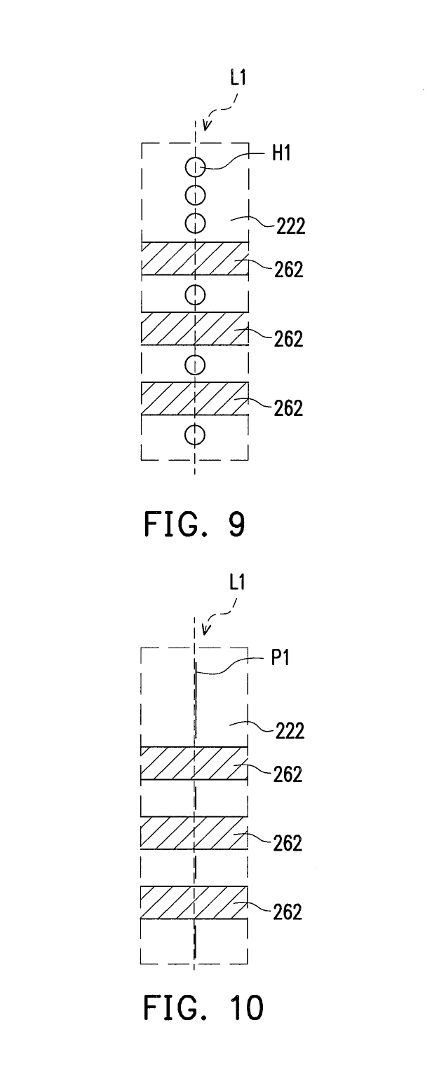

FIG. 9 is a partial enlarged view of the folding line of FIG. 4 at an area A1. Referring to FIG. 9, in the embodiment, each folding line L1 includes a plurality of holes H1 and the holes H1 can be formed on the first flexible substrate 222 by punching process, and the holes H1 respectively avoid the corresponding first connection lines 262. In addition, the holes H1 can be disposed on appropriate positions depending on the requirement, for example, the multiple holes H1 can be adjacent to each other or separated from a distance. The holes H1 in the embodiment is, for example, circle shape. The user can change the shape of the holes H1 depending on their requirements, for example, ellipse shape.

FIG. 10 is a partial enlarged view of the folding line of FIG. 4 at the area A1 according to another embodiment of the disclosure. Referring to FIG. 10, in the embodiment, each folding line L1 includes at least one indent P1, in which the indent P1 can be formed on the first flexible substrate 222 by imprinting process and need to respectively avoid the corresponding first connection lines 262. The disclosure does not limit the forming method of the folding line L1 and the user can select an appropriate method depending on the using requirement.

Referring to FIGS. 4 and 5, in more details, the first sensing circuit 260 in the embodiment can be located on a first surface S1 of the first flexible substrate 222 and the first sensing circuit 260 further includes a sensing array 264, a plurality of first pads 266, a plurality of second pads 268 and a plurality of second connection lines 269. The sensing array 264 is located on the body 222a of the first flexible substrate 222 and includes a plurality of first sensing electrodes 264a and a plurality of second sensing electrodes 264b. In the embodiment, the first connection lines 262, the first sensing electrodes 264a, the second sensing electrodes 264b, the first pads 266, the second pads 268 and the second connection lines 269 of the touch panel 220 can be disposed on a same plane of the first flexible substrate 222. In other words, the touch panel 220 of the embodiment is a touch panel with a coplanar sensing circuit. However, the touch panel is not limited to adopt the coplanar sensing circuit, and the touch panel with different structures are explained in following.

The first pads 266 are located at the peripheral of the first flexible substrate 222, and the first connection lines 262 are respectively connected between the first sensing electrodes 264a and the first pads 266. The second pads 268 are located at the peripheral of the first flexible substrate 222. The second connection lines 269 are respectively connected between the second sensing electrodes 264b and the second pads 268. In more details, the first sensing electrodes 264a are arranged along a first direction D1 and the second sensing electrodes 264b are arranged along a second direction D2, and the sensing array 264 thus becomes an array structure. The first direction D1 herein is different from the second direction D2. The materials of each first sensing electrode 264a and each second sensing electrode 264b are respectively a transparent conductive film made of, for example, indium tin oxide (ITO) or other similar materials. In addition, in the embodiment, the shapes of the first sensing electrodes 264a and the second sensing electrodes 264b are, for example, rhombus, and people skilled in the art can change the shape, position and quantity of the sensing electrodes depending on the real requirement. In addition, the material of the second connection lines 269 can be the same as or different from the material of the first connection lines 262.

The touch display device 200 in the embodiment further includes a transparent upper cover 230, and two optical glues O1 and O2 are respectively disposed at the bottom surface and the top surface of the touch panel 220. After the touch panel 220 is assembled to the casing 10, the transparent upper cover 230 and the touch panel 220 are adhered. The material of the transparent upper cover can be glass or plastic with transparency, and the peripheral of the transparent upper cover 230 has a shielding portion 232 for shielding the first connection lines 262 or other opaque component structures. After the extension portion 222b of the first flexible substrate 222 is bent, the first portions 262a of the first connection lines 262 are located at the side edge of the display panel 210 so as to reduce the range of the shielding portion 232. In this way, after the range of the shielding portion 232 gets reduced, the non-display area around the display device gets reduced as well, which makes the space inside the device have larger flexibility of the design and conform with the design requirement of slim boarder for getting a bigger viewable area.

Referring to FIGS. 2 and 3, the display panel 210 in the embodiment is an LCD panel, which includes a first substrate 212, a second substrate 214 opposite to the first substrate 212, an liquid crystal layer 216 deposed between the first substrate 212 and the second substrate 214 and a first polarizer 218 and a second polarizer 219 respectively at the external side of the first substrate 212 and the external side of the second substrate 214. In addition, the optical glue O1 of the touch panel 220 is adhered to the second polarizer 219 to fix the relative position of the touch panel 220 to the display panel 210. The touch display device 200 further includes a backlight module 240 and a carrying frame 250. The backlight module 240 is disposed under the display panel 210 for providing a backlight source to the display panel 210, while the carrying frame 250 surrounds and supports the display panel 210.

After the extension portion 222b of the first flexible substrate 222 is bent along the folding line L1 (referring to FIG. 4), the extension portion 222b can be adhered to the side surface 252 of the carrying frame 250 through the optical glue O1. In this way, the risk for the touch panel 220 and the display panel 210 to produce relative movements can be reduced and the touch panel 220 can be adhered in level to the display panel 210.

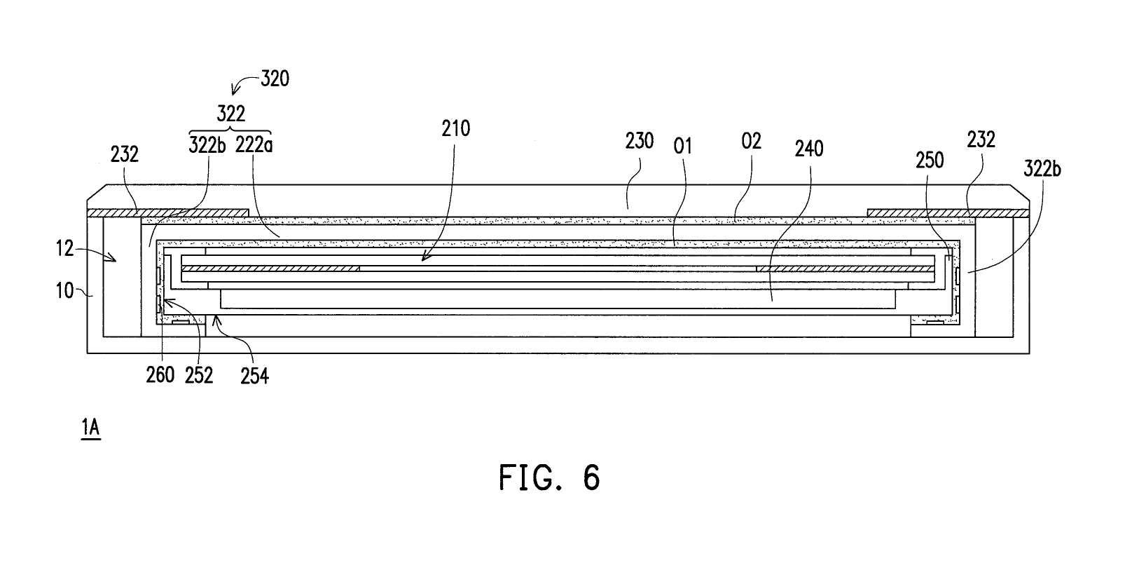

FIG. 6 is a cross-sectional view of a handheld electronic device according to another embodiment of the disclosure. Referring to FIG. 6, a handheld electronic device 1A is similar to the handheld electronic device 1 in FIG. 2. In following, the difference between the two embodiments of FIGS. 6 and 2 is described, in which the same or similar component notations represent the same or similar components, which are omitted to describe. In the embodiment, the extension portion 322b of the first flexible substrate 322 in the handheld electronic device 1A extends further, to outside the display panel 210. After the extension portion 322b of the first flexible substrate 322 is bent along the folding line L1 (referring to FIG. 4), the extension portion 322b is adhered to a bottom surface 254 of the carrying frame 250, or to the side surface 252 and the bottom surface 254 of the carrying frame 250 by the optical glue 01. In this way, the touch panel 320 and the display panel 210 get fixed.

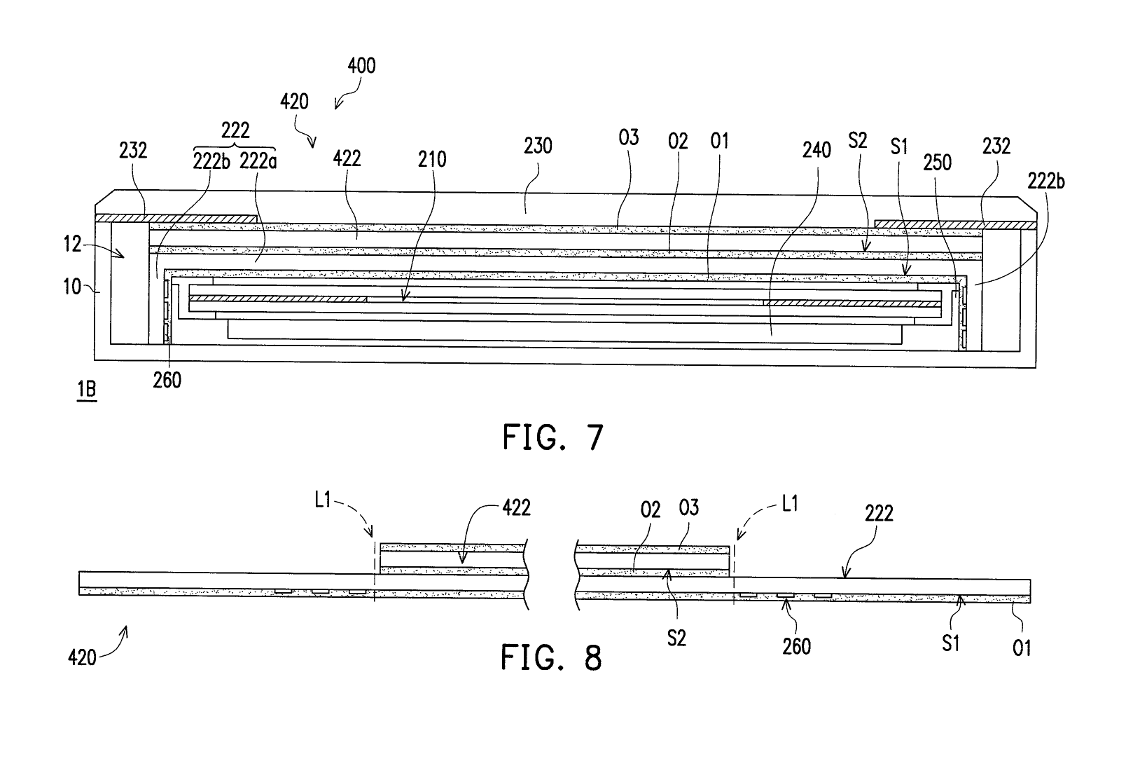

FIG. 7 is a cross-sectional view of a handheld electronic device according to yet another embodiment of the disclosure and FIG. 8 is a cross-sectional view of the touch panel of FIG. 7 when it is outspread. It should be noted that for better understanding the view, the ratio of the touch panel 420 in FIG. 8 is adjusted. Referring to FIGS. 7 and 8, a handheld electronic device 1B of the embodiment is similar to the handheld electronic device 1 in FIG. 2. The sensing circuit of the touch panel 420 in the embodiment is similar to the first sensing circuit 260 in FIGS. 4 and 5, in which the notations of the same and similar components represent the same or similar components, which are omitted to describe. In the embodiment, the touch panel 420 further includes a second flexible substrate 422 disposed on the body 222a of the first flexible substrate 222, and the second flexible substrate 422 exposes out the extension portion 222b of the first flexible substrate 222. The first flexible substrate 222 and the second flexible substrate 422 are fixed by an optical glue O2, the second flexible substrate 422 and the transparent upper cover 230 are fixed by another optical glue O3. In addition, the material of the second flexible substrate 422 can be the same as or different from the material of the first flexible substrate 222.

The sensing circuit of the embodiment includes a first sensing circuit 260 as shown by FIG. 4 and a second sensing circuit 270 as shown by FIG. 5. The first sensing circuit 260 is located on the first surface S1 of the first flexible substrate 222, the second sensing circuit 270 is located on a second surface S2 of the second flexible substrate 422 and the second surface S2 is opposite to the first surface S 1. In more details, in the embodiment, the first sensing circuit 260 includes the first connection lines 262, the first sensing electrodes 264a and the first pads 266. The second sensing circuit 270 includes the second connection lines 269, the second sensing electrodes 264b and the second pads 268. In other words, the touch panel 420 of the embodiment is a touch panel with non-coplanar sensing circuit.

As a result, the difference of the touch panel 420 in the embodiment from the touch panel 220 in FIG. 2 rests in that the components of the sensing circuit of the touch panel 220 in FIG. 2 are disposed on a same surface of a substrate to make the touch panel 220 integrally thin, while the components of the two sensing circuits of the touch panel 420 in the embodiment are disposed on two surfaces of two substrates, which is easier to fabricate the touch panel 420. The disclosure does not limit the layout of the sensing circuits and they can be coplanar or non-coplanar and the user can adjust the layout and disposing depending on the real requirement.

In summary, in the disclosure, the extension portion of the first flexible substrate extends out of the display panel, and the line-width of the first portion of each the first connection line passing through the folding line is greater than the line-width of the second portion located outside the first portion. Therefore, after the first flexible substrate is bent, the extension portion is located at the side edge of the display panel to shield the first portions of the first connection lines, which can reduce the non-displaying area of the display device, and in this way, it can make the design of the space inside the display device have larger flexibility to conform with the design requirement of slim boarder. In addition, since the line-width of the first portion of each of the first connection lines is greater than the line-width of the second portion located outside the first portion, when the first connection lines bend, the first connection lines still can maintain quite strength to avoid the first connection lines from fracture to fail transmitting the signals. Further, the material of the first connection lines include metal, for example, copper or gold so that the first connection lines at bending have better ductility. In addition, the sensing circuits of the touch panel can be coplanar structure or non-coplanar structure.

It will be apparent to those skilled in the art that the descriptions above are several preferred embodiments of the disclosure only, which does not limit the implementing range of the disclosure. Various modifications and variations can be made to the structure of the disclosure without departing from the scope or spirit of the disclosure. The claim scope of the disclosure is defined by the claims hereinafter.

What is claimed is:

1. A touch display device, comprising:
a display panel; and
a touch panel, comprising:
a first flexible substrate, comprising a body disposed on the display panel and an extension portion located outside the display panel, wherein the extension portion is connected to the body and bent relatively to the body; and
a sensing circuit, comprising a plurality of first connection lines disposed on the first flexible substrate.

2. The touch display device as claimed in claim 1, wherein the extension portion is adapted to bend relatively to the body along a folding line.

3. The touch display device as claimed in claim 2, wherein the folding line comprises a plurality of holes or at least one indent which avoid each the first connection line.

4. The touch display device as claimed in claim 2, wherein each the first connection line has a first portion passing through the folding line and a second portion located outside the first portion, wherein line-width of the first portion is greater than line-width of the second portion.

5. The touch display device as claimed in claim 4, wherein the line-width of the first portion of each the first connection line is between 0.1 μm and 10 μm.

6. The touch display device as claimed in claim 4, wherein the line-width of the first portion of each of the first connection lines is between 3 μm and 5 μm.

7. The touch display device as claimed in claim 1, wherein material of the first connection lines comprises metal.

8. The touch display device as claimed in claim 1, wherein material of the first connection lines comprises copper or gold.

9. The touch display device as claimed in claim 1, wherein the sensing circuit is located on a first surface of the first flexible substrate and the sensing circuit further comprises:
a sensing array, located on the body and comprising a plurality of first sensing electrodes and a plurality of second sensing electrodes;
a plurality of first pads located at peripheral of the first flexible substrate, wherein the first connection lines are respectively connected between the first sensing electrodes and the first pads;
a plurality of second pads located at peripheral of the first flexible substrate; and
a plurality of second connection lines, respectively connected between the second sensing electrodes and the second pads.

10. The touch display device as claimed in claim 1, wherein the touch panel further comprises a second flexible substrate disposed on the body of the first flexible substrate, the second flexible substrate exposes out the extension portion, and the sensing circuit further comprises:
a first sensing circuit, located on a first surface of the first flexible substrate and comprising:
a plurality of first sensing electrodes located on the body;
a plurality of first pads located at peripheral of the first flexible substrate; and
the first connection lines, respectively connected between the first sensing electrodes and the first pads; and
a second sensing circuit, located on a second surface opposite to the first surface of the second flexible substrate and comprising:
a plurality of second sensing electrodes;
a plurality of second pads located at peripheral of the second flexible substrate; and
a plurality of second connection lines, respectively connected between the second sensing electrodes and the second pads.

11. The touch display device as claimed in claim 1, wherein the display panel is a liquid crystal display panel.

12. The touch display device as claimed in claim 11, further comprising a backlight module disposed under the display panel.

13. The touch display device as claimed in claim 1, further comprising a carrying frame surrounding and supporting the display panel.

14. The touch display device as claimed in claim 13, wherein the extension portion is bent and adhered to a side surface of the carrying frame.

15. The touch display device as claimed in claim 14, wherein the extension portion further extends and is adhered to a bottom surface of the carrying frame.

16. The touch display device as claimed in claim 1, further comprising a transparent upper cover adhered onto the touch panel.

17. A handheld electronic device, comprising:
a casing, having an accommodation opening; and
the touch display device as claimed in claim 1, which is disposed in the accommodation opening.
